(19) United States
(12) Patent Application Publication
(10) Pub. No.: US 2026/0021574 A1
(43) Pub. Date: Jan. 22, 2026

(54) ACTIVELY VARIABLE STIFFNESS AND TRANSMISSION MECHANISM BASED ON 4-BAR LINKAGE FOR ROBOTS

(71) Applicant: SOGANG UNIVERSITY RESEARCH & BUSINESS DEVELOPMENT FOUNDATION, Seoul (KR)

(72) Inventors: Seokhwan JEONG, Gyeonggi-do (KR); Jungwoo Hur, Seoul (KR); Hangyeol Song, Seoul (KR); Junho Choi, Seoul (KR)

(73) Assignee: SOGANG UNIVERSITY RESEARCH & BUSINESS DEVELOPMENT FOUNDATION, Seoul (KR)

(21) Appl. No.: 19/265,263

(22) Filed: Jul. 10, 2025

(30) Foreign Application Priority Data
Jul. 17, 2024 (KR) 10-2024-0094442
Apr. 23, 2025 (KR) 10-2025-0053062

(51) Int. Cl. B25J 9/10; B25J 9/00; B25J 9/12; B25J 19/00

(52) U.S. Cl. CPC B25J 9/106; B25J 9/0009; B25J 9/126; B25J 19/0041

(57) ABSTRACT

Disclosed herein is a robot with active variable stiffness and transmission mechanism, which is capable of simultaneously controlling the transmission ratio and stiffness of an actuation unit, thereby increasing the stiffness in a low transmission ratio range to enhance system bandwidth while decreasing the stiffness in a high transmission ratio range to make it resistant to system-applied shocks during operation.

### TECHNICAL FIELD

The present disclosure relates to a robot with active variable stiffness and transmission mechanism, which is capable of simultaneously controlling the transmission ratio and stiffness of an actuation unit.

### RELATED ART

Various robots have developed rapidly in recent years, and quadruped walking robots are utilized in various fields of industry for example. The quadruped walking robots are utilized in various fields such as for inspection, cargo transportation, or military reconnaissance by having thermal imaging cameras or vision cameras attached thereto.

Most of the robots that are currently available use electric-motor-based actuators. They have the advantage of easy control and miniaturization compared to hydraulic and pneumatic actuators.

Meanwhile, most conventional robots adopt a single gear ratio to simplify their designs. For this reason, there may be limitations on the versatility of the robots depending on the task thereof.

More specifically, the actuators that are mainly used for the conventional robots may be broadly classified into three types: QDD, SEA, and spindle drive.

The QDD actuator may reduce energy loss due to reflected inertia and friction by combining a high torque motor with a low-gear-ratio transmission. Therefore, it has the advantage of very fast control bandwidth, torque control through current, and so on.

However, the QDD actuator has a relatively low torque capacity compared to other actuators combined with a high gear ratio, which may limit robot payloads.

On the other hand, the SEA and spindle drive actuators may have a high torque capacity by utilizing a transmission with a relatively high gear ratio. However, these actuators may have limitations such as reduced control bandwidth due to additional springs or inability to implement dynamic tasks to protect themselves from external shocks.

For these reasons, the development of continuously variable transmission (CVT) mechanism that is applicable to robots is required. However, the following problems may arise when immediately applying this CVT mechanism.

Applying the CVT mechanism to the QDD actuator may increase loss due to reflected inertia and friction when gear shifting is performed at a high gear ratio. This may cause loss of reverse drivability and make the actuator vulnerable to shocks.

Of course, the actuator may be designed to be shock-resistant by means of springs, in which case, however, the control bandwidth thereof may be significantly reduced due to the unnecessary elasticity of the springs when gear shifting is performed at a low gear ratio.

In other words, in order to perform various tasks in the actuator, it is necessary to change not only the gear ratio thereof but also the stiffness thereof. Therefore, there is a need to implement a mechanism that combines variable transmission mechanism with variable stiffness mechanism.

### CITATION LIST

### Patent Document

(Patent Document 1) Korean Patent Application Publication No. 10-2022-0105525 (Jul. 27, 2022)

### DESCRIPTION OF THE INVENTION

### Problems to be Solved by the Invention

The present disclosure has been made in view of the above-mentioned problems, and an object of the present disclosure is to provide a robot with active variable stiffness and transmission mechanism, which is capable of simultaneously controlling the transmission ratio and stiffness of an actuation unit, thereby increasing the stiffness in a low transmission ratio range to enhance system bandwidth while decreasing the stiffness in a high transmission ratio range to make it resistant to system-applied shocks during operation.

### Means for Solving the Problems

In accordance with an aspect of the present disclosure, there is provided a robot with active variable stiffness and transmission mechanism, which includes a main body, an actuation unit installed in the main body and including a first motor to rotate a swivel panel in forward and reverse directions at a predetermined angle, a link unit including an input link coupled in a direction intersecting with an axis of the first motor to the swivel panel so as to be able to idle, a ground link having one end coupled so as to be pivotable about the axis of the first motor, a connecting link having one end reciprocatably screwed to an outer peripheral surface of the input link and the other end disposed in a direction intersecting with the input link, and an output link having one end pivotably coupled to the other end of the connecting link and the other end pivotably coupled to the other end of the ground link, a swivel unit extending from the other end of the output link in its longitudinal direction by a predetermined length and swiveled at a predetermined angle when the first motor is operated in the forward and reverse directions, and a control unit configured to control a transmission ratio of the swivel unit depending on the situation by including a motor configured to rotate the input link in the forward and reverse directions so as to adjust a length of the input link by increasing or decreasing a distance between the axis of the first motor and one end of the connecting link.

The actuation unit may include a second motor disposed on the same axis as the first motor and coupled to one end of the ground link to reciprocatably swivel the other end of the ground link about the axis at a predetermined angle.

The ground link may have one end integrally coupled to the first motor so that the first motor and the ground link are swiveled simultaneously when the second motor is operated.

The connecting link may be in the form of a length-adjustable turnbuckle to adjust a setting angle of the swivel unit.

The robot may further include a stiffness adjustment unit configured to adjust stiffness depending on the length of the input link, in which one end of the input link is hinged to one surface of the swivel panel, the other end of the input link is disposed as a free end so as to swivel about one end of the input link toward a direction of placement of the connecting link, and the swivel panel is provided on both sides thereof with a pair of springs with the other end of the input link interposed therebetween to elastically support the other end of the input link.

One end of the input link may be hinged to one surface of the swivel panel via a rod end bearing.

The stiffness adjustment unit may include a fixed bracket installed to be spaced apart from and face one surface of the swivel panel with the other end of the input link interposed therebetween, a guide rail installed in a swivel direction of the swivel panel on an opposite surface of the fixed bracket, a movable member slidably and reciprocatably coupled to the guide rail and to which the other end of the input link is pivotably coupled, and the pair of springs fitted to an outer peripheral surface of the guide rail with the movable member interposed therebetween to elastically support the movable member.

The robot may further include a third motor installed in a direction intersecting with the axis of the first and second motors to rotate the main body in the forward and reverse directions about the axis in the intersection direction.

The swivel unit may constitute a leg or arm of the robot.

### Effect of the Invention

According to the configuration described above, the robot employing the actively variable stiffness and transmission mechanism of the present invention is capable f simultaneously adjusting the transmission ratio and stiffness of the actuation unit using a single motor. In a low transmission ratio range, the stiffness can be increased to enhance the system bandwidth, thereby enabling faster and more precise response. In a high transmission ratio range, the stiffness can be decreased to provide improved resistance against shocks applied to the system during operation.

### BRIEF DESCRIPTION OF THE DRAWINGS

FIG. 1 is a perspective view illustrating a robot with active variable stiffness and transmission mechanism according to a first embodiment of the present disclosure.

FIG. 2 is an exploded perspective view of FIG. 1.

FIG. 3 is a side view of FIG. 1.

FIG. 4 is a side view illustrating a trajectory of a swivel unit during operation of the first motor of the robot according to the first embodiment of the present disclosure.

FIG. 5 is a side view illustrating the trajectory of the swivel unit during simultaneous operation of the first and second motors of the robot according to the first embodiment of the present disclosure.

FIGS. 6A and 6B are views illustrating a state in which an input link is adjusted in length according to the first embodiment of the present disclosure.

FIGS. 7 and 8 are photographs, substituted for drawings, illustrating a state of operation of the robot according to the first embodiment of the present disclosure.

FIGS. 9 to 13 illustrate experimental results of the performance of the robot according to the first embodiment of the present disclosure.

FIG. 14 is a perspective view illustrating a robot according to a second embodiment of the present disclosure.

FIG. 15 is an exploded perspective view of FIG. 14.

FIG. 16 is a side view of FIG. 14.

### DETAILED DESCRIPTION

Hereinafter, the configuration and operation of the specific embodiments of the present disclosure will be described in detail with reference to the accompanying drawings.

It should be noted that reference numerals are added to the components of the accompanying drawings to facilitate understanding of the embodiments described below and the same reference numbers will be marked throughout the drawings to refer to the same or like parts wherever possible.

### First Embodiment

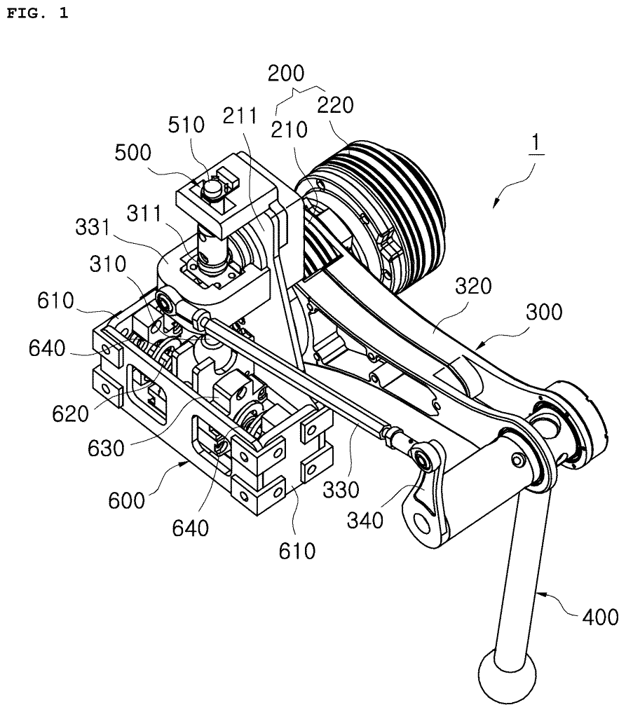

FIG. 1 is a perspective view illustrating a robot with active variable stiffness and transmission mechanism according to a first embodiment of the present disclosure.

Referring to FIG. 1, the robot with active variable stiffness and transmission mechanism, which is designated by reference numeral 1, according to the first embodiment of the present disclosure may include a main body 100, an actuation unit 200, a link unit 300, a swivel unit 400, and a control unit 500.

The configuration of the present disclosure will be described in detail as follows.

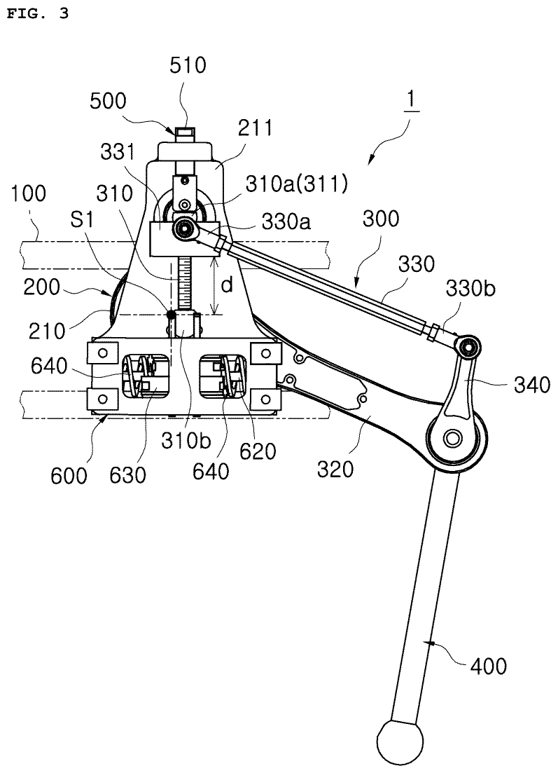

The main body 100 (see FIG. 3) constitutes a part of the body of the robot 1, and may be formed in different structures depending on the type and intended use of the robot 1. In this case, the main body 100 may be a part of the constituent body of the robot 1.

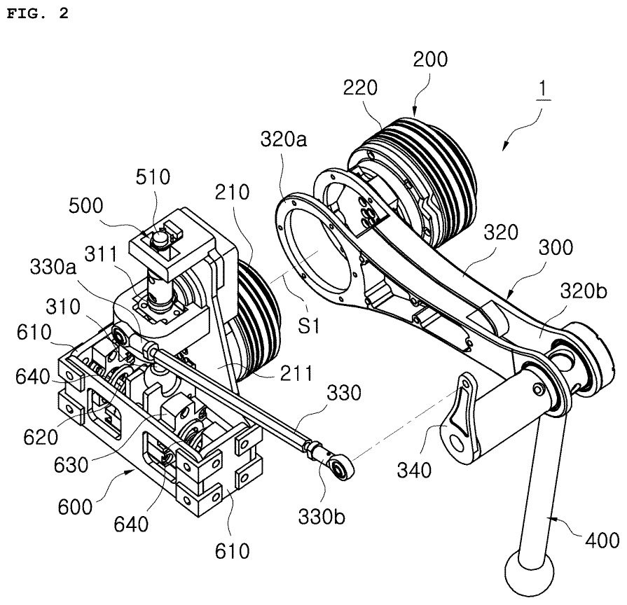

Referring to FIG. 2, the actuation unit 200 is installed in the main body 100, and may have a first motor 210 that supplies rotational power to the link unit 300 to be described later. A swivel panel 211 may be integrally coupled to the drive shaft of the first motor 210. Accordingly, the swivel panel 211 may be rotated back and forth within a predetermined angle during forward and reverse rotation of the first motor 210.

The actuation unit 200 may also have a second motor 220 that is disposed in series on the axis S1 of the first motor 210 to operate separately from the first motor 210.

The first and second motors 210 and 220 may individually swivel a ground link 320 and connecting link 330 of the link unit 300, which will be described later. Accordingly, the swivel unit 400 of the robot 1 may implement a walking motion while drawing a predetermined trajectory T2. The method of operation of the robot 1 using the first and second motors 210 and 220 will be specifically described in reference to the link unit 300 and the swivel unit 400 to be described later.

Referring to FIG. 3, the link unit 300 may be configured to implement the walking motion of the robot 1 by receiving the rotational power of the actuation unit 200. The link unit 300 may be of a four-bar linkage structure that is operatably linked by the first and second motors 210 and 220.

Specifically, the link unit 300 may include an input link 310 that is coupled in a direction intersecting with the axis S1 of the first motor 210 to the swivel panel 211 so as to be able to idle, a ground link 320 that has one end 320a coupled so as to be pivotable about the axis S1 of the first motor 210, a connecting link 330 that has one end 330a reciprocatably screwed to the outer peripheral surface of the input link 310 and the other end 330b disposed in a direction intersecting with the input link 310, and an output link 340 that has one end pivotably coupled to the other end 330b of the connecting link 330 and the other end pivotably coupled to the other end 320b of the ground link 320.

In this case, the input link 310 may be formed as a lead screw with a predetermined length. The connecting link 330 may have one end 330a screwed to the outer peripheral surface of the input link 310 via a movable nut 331 so as to be reciprocatable longitudinally. Accordingly, when the input link 310 is rotated, the length of the input link 310 may be adjusted by adjusting the position of one end 330a of the connecting link 330 in the longitudinal direction of the input link 310.

In addition, the connecting link 330 may be in the form of a length-adjustable turnbuckle. Accordingly, when the body of the connecting link 330 is rotated about the axis of the connecting link 330, both ends 330a and 330b screwed to the body of the connecting link 330 may be increased or decreased in length in opposite directions. This operation may allow for adjusting the setting angle of the swivel unit 400, which will be described later, integrally coupled to the output link 340.

In addition, the ground link 320 may have one end 320a that is coupled to the outer peripheral surface of the first motor 210 and fixed to the drive shaft of the second motor 220 (see FIG. 2). Accordingly, when the second motor 220 is operated, the first motor 210 and the other end 320b of the ground link 320 may be swiveled simultaneously.

In this case, the part where the other end 320b of the ground link 320 and the other end of the output link 340 are pivotably connected to each other may act as a knee joint of the robot 1.

The swivel unit 400 extends from the other end of the output link 340 in the longitudinal direction thereof by a predetermined length. The swivel unit 400 may be linked and swiveled at a predetermined angle by the operation of the link unit 300 when the first motor 210 rotates in the forward and reverse directions. In other words, the swivel unit 400 may act as a leg of the walking robot 1 in the first embodiment of the present disclosure.

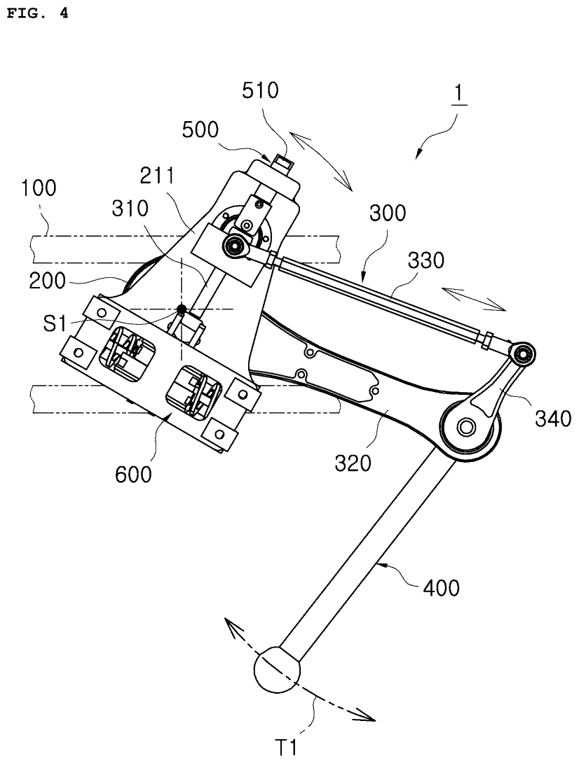

Specifically, when the first motor 220 is operated, the input link 310 rotates in the forward and reverse directions about the axis S1, and the swivel unit 400 is swiveled by the operation of the connecting link 330 and the output link 340 linked to the input link 310 while drawing a predetermined trajectory T1 (see FIG. 4).

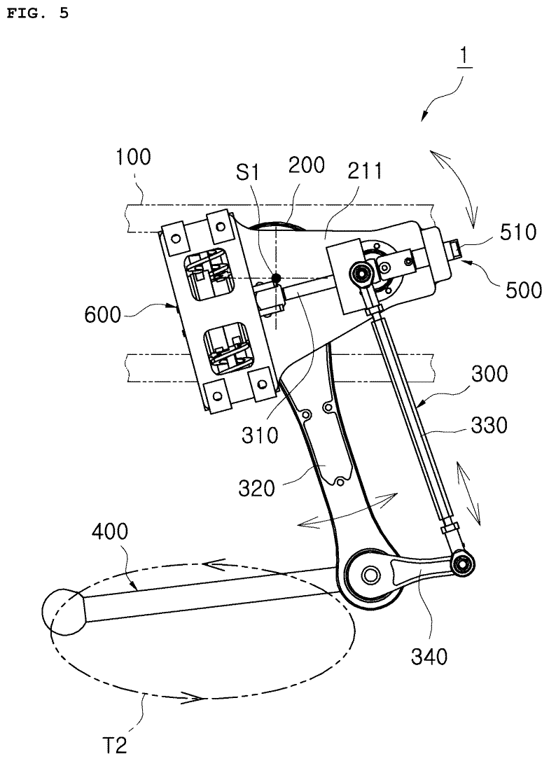

In this state, when the second motor 220 is operated, the ground link 320 rotates in the forward and reverse directions about the axis S1, and the end of the swivel unit 400 draws a predetermined elliptical trajectory T2 (see FIG. 5).

The control unit 500 may control the stiffness and transmission ratio of the swivel unit 400 depending on the walking situation of the robot 1.

Specifically, the control unit 500 may include a motor 510 that rotates the input link 310 in the forward and reverse directions. Preferably, the motor 510 may be a clutch motor. The motor 510 may serve to increase or decrease a distance d between the axis S1 of the first motor 210 and one end of the connecting link 330 (see FIG. 3), which allows to adjust the length of the input link 310.

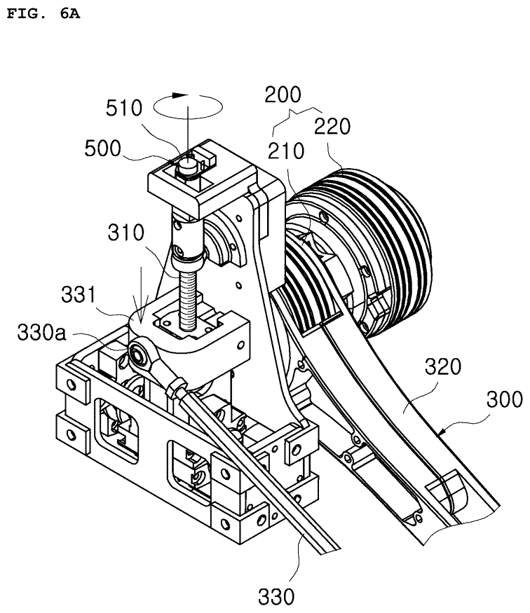

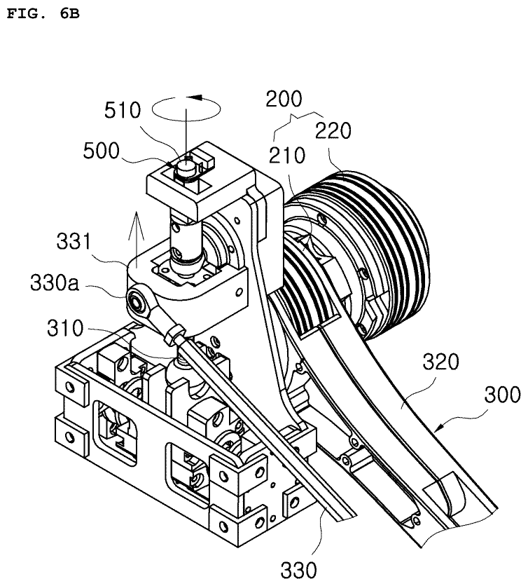

In other words, as illustrated in FIG. 6A, if the length of the input link 310 becomes shorter, the transmission ratio (TR) increases, and at the same time, the distance d between one end 330a of the connecting link 330, which is a force point, and the axis S1 becomes shorter, which decreases the stiffness. In this case, the robot may have a system that is resistant to external shocks at a high transmission ratio.

In contrast, as illustrated in FIG. 6B, if the length of the input link 310 becomes longer, the transmission ratio decreases, and at the same time, the distance d between one end 330a of the connecting link 330, which is a force point, and the axis S1 becomes longer, which increases the stiffness.

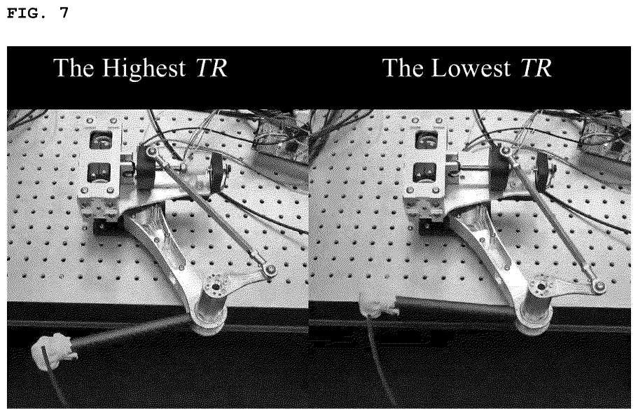

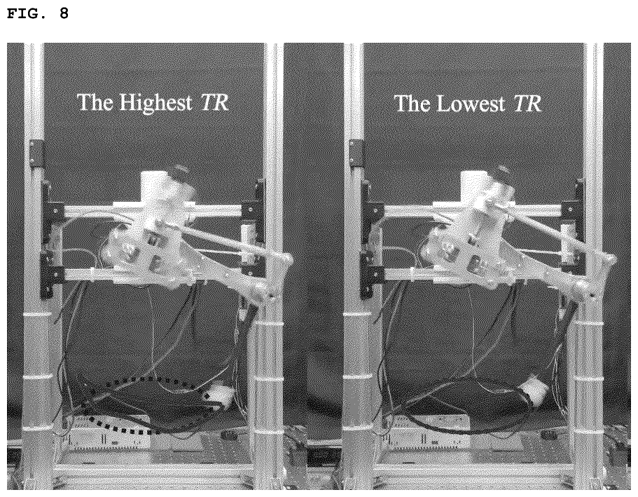

FIGS. 7 and 8 are actual photographs illustrating a state in which the swivel trajectory of the swivel unit 400 changes depending on the difference in length of the input link 310 and whether to operate the first and second motors 210 and 220.

Specifically, in FIGS. 7 and 8, the left photographs illustrate that the length of the input link 310 becomes shorter, and the right photographs illustrate that the length of the input link 310 becomes longer.

Here, FIG. 7 illustrates the swivel trajectory T1 of the swivel unit 400 when only the first motor 210 is operated. FIG. 8 illustrates the swivel trajectory T2 of the swivel unit 400 when both the first and second motors 210 and 220 are operated.

In addition, the robot 1 may include a stiffness adjustment unit 600 that adjusts the stiffness depending on the length of the input link 310 to be adjusted.

Referring again to FIGS. 2 and 3, the stiffness adjustment unit 600 may be configured so that one end of the input link 310 is hinged to one surface of the swivel panel 211, and the other end of the input link 310 is disposed as a free end so as to be able to swivel about one end of the input link 310 toward the direction of placement of the connecting link 330. The stiffness adjustment unit 600 may be of a structure that includes a pair of springs 640 arranged on both sides of the swivel panel 211 with the other end of the input link 310 interposed between the springs to elastically support the other end of the input link 310.

In this case, one end 310a of the input link 310 may be hinged to one side of the swivel panel 211 via a rod end bearing 311.

The structure for elastically supporting the other end 310b of the input link 310 will be described in more detail. The stiffness adjustment unit 600 may include a fixed bracket 610 that is installed to be spaced apart from and face one surface of the swivel panel 211 with the other end of the input link 310 interposed therebetween, a guide rail 620 that is installed in the swivel direction of the swivel panel 211 on the opposite surface of the fixed bracket 610, a movable member 630 that is slidably and reciprocatably coupled to the guide rail 620 and to which the other end of the input link 310 is pivotably coupled, and a pair of springs 640 that are fitted to the outer peripheral surface of the guide rail 620 with the movable member 630 interposed therebetween to elastically support the movable member 630.

The operation of the robot with active variable stiffness and transmission mechanism 1 according to the first embodiment of the present disclosure having the above configuration will be described in detail.

The four-bar-linkage-based robot 1 according to the first embodiment of the present disclosure is able to simultaneously change the transmission ratio and stiffness of the actuation unit 200 through control of the motor 510.

In other words, the robot 1 of the present disclosure is able to increase the stiffness in a low transmission ratio range to enhance system bandwidth while decreasing the stiffness in a high transmission ratio range to make it resistant to system-applied shocks during operation.

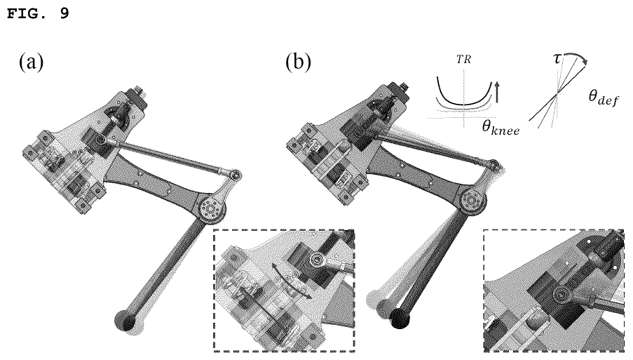

FIG. 9 illustrates CVT-VSA mechanism according to the first embodiment of the present disclosure, wherein the CVT may change the transmission ratio by adjusting the length of the input link 310 of the four-bar linkage.

In this case, one end (330a) of the connecting link (330) (see FIG. 3), which is reciprocatably screwed to the input link 310, serves as a force point of the input link (310) in the VSA, and the stiffness changes as the force point moves. As illustrated in FIG. 9(b), as the length of the input link 310 becomes shorter, the transmission ratio increases, and at the same time, the distance between the force point and the spring point becomes shorter, which may decrease the stiffness.

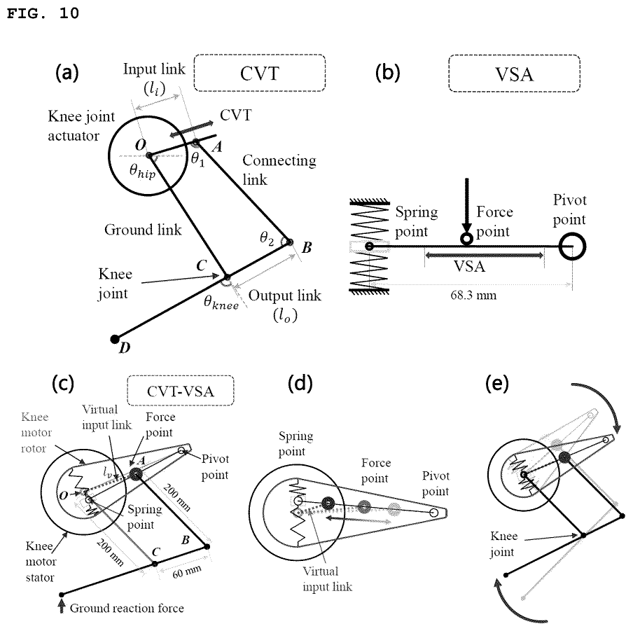

FIG. 10(a) illustrates a four-bar-linkage-based transmission, wherein the torque of the knee joint may be determined by the input link 310, the output link 340, and the angle between links, as in Equation (1) below.

$$\begin{matrix}{τ}_{knee} = \frac{\overline{BC} sin ( ∠ OAB )}{\overline{OA} sin ( ∠ ABC )} {τ}_{input} = \frac{{l}_{o} sin ( {θ}_{1} )}{{l}_{i} sin ( {θ}_{2} )} {τ}_{input} \\ = TR ( {θ}_{1} , {θ}_{2} , {l}_{i} , {l}_{o} ) {τ}_{input}\end{matrix} \qquad Equation ( 1 )$$

In the above Equation (1), OA, which is the length of the input link 310, may be adjusted through the input link 310 as a lead screw structure to achieve the low moment of inertia of the swivel unit 400.

FIG. 10(b) illustrates the variable stiffness mechanism of the lever-based input link 310, wherein the position of point A (see FIG. 10(a)) may be controlled by the motor 510 to change the length of the input link 310. Point A is also a force point in the input link 310 at the same time.

The input link 310 positions a spring point close to the center of rotation of the first motor (knee motor) 210, and positions a pivot point beyond point A as illustrated in FIGS. 10(c) and 10(d). Accordingly, it is possible to decrease the stiffness to make the system resistant to external shocks at a high transmission ratio and to increase the stiffness for fast response at a low transmission ratio to enhance the bandwidth of the system.

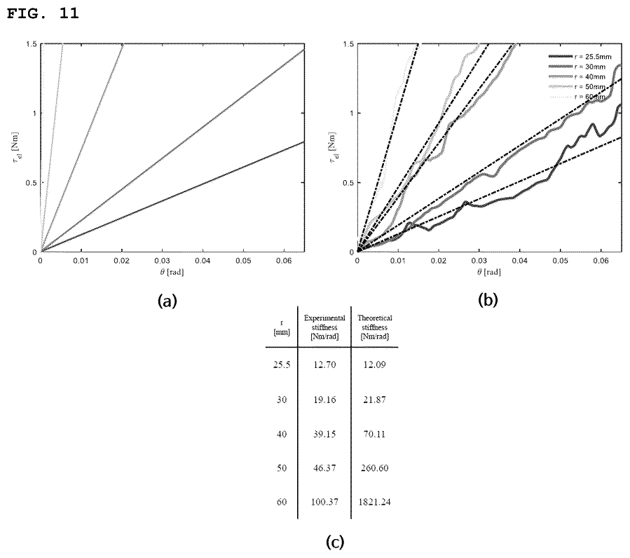

In this case, the force point in the input link 310 and the rotor of the first motor 210 play the same role as the input link 310, and may be considered as a virtual input link from the rotor center of the first motor 210 to the force point. FIG. 11 illustrates experimental data of the deformation angle and torque of the virtual input link for each input link length.

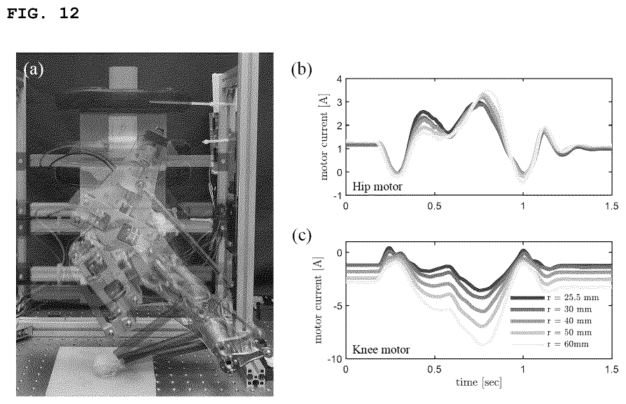

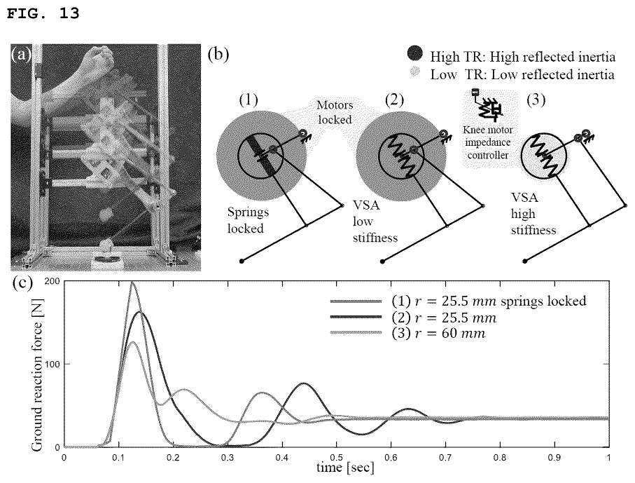

FIGS. 12 and 13 illustrate experimental results of the performance of the robot 1 according to the first embodiment of the present disclosure.

FIGS. 12 and 13 illustrate the current consumption of the motor for each experimental environment and transmission ratio when one leg of the robot 1 lifts its own weight by about 0.1 m. In this case, it can be seen that, when the length of the input link 310 is short, the transmission ratio is high and the current consumption is relatively low.

FIG. 13 illustrates how the impact time changes on the force sensor fixed to the ground for the same amount of impact when the robot 1 is dropped from the same height. In this case, when the length of the input link 310 is 60 mm, it is back-drivable, so the impact time varies depending on the impedance controller coefficient of the motor.

This impact experiment may compare, at 25.5 mm, which is the length of the input link 310 with the highest transmission ratio, when the spring is prevented from physically deforming with when the spring is allowed to deform. It can be seen that the CVT-VSA mechanism significantly increases the impact time at the high transmission ratio compared to when the spring does not deform and also decreases the magnitude of the maximum impact force.

### Second Embodiment

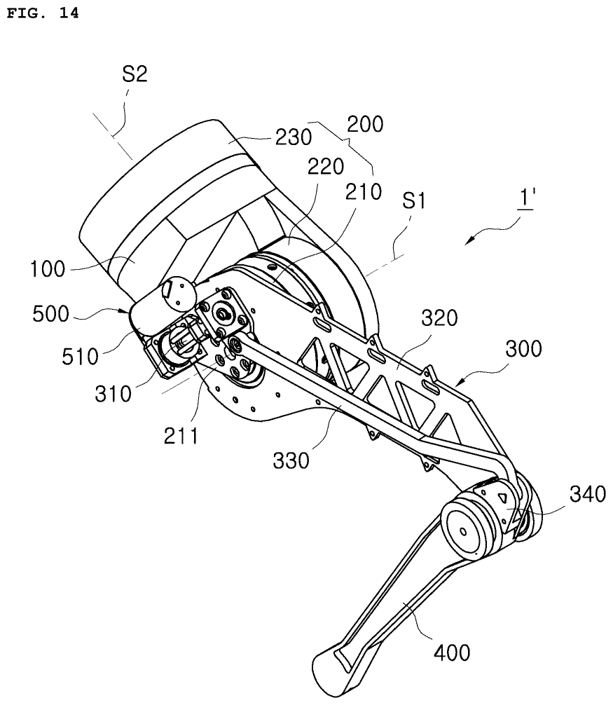

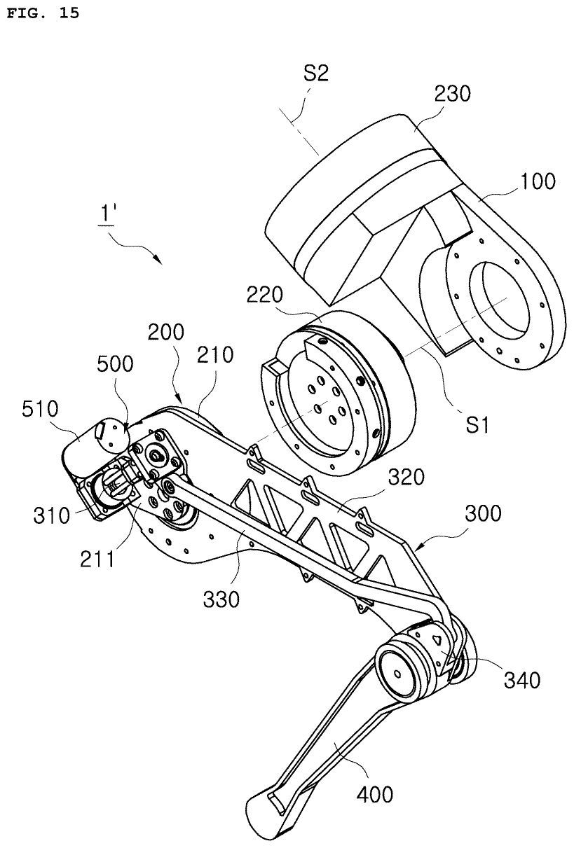

FIG. 14 is a perspective view illustrating a robot according to a second embodiment of the present disclosure. FIG. 15 is an exploded perspective view of FIG. 14.

Referring to FIGS. 14 and 15, the robot, which is designated by reference numeral 1′, according to the second embodiment of the present disclosure may be operated on the same principle as and including most of the components of the robot 1 according to the first embodiment. In addition, the robot 1′ according to the second embodiment of the present disclosure may further include a third motor 230 for rotating the main body 100 such that it is applicable to an arm.

In other words, the robot 1′ according to the second embodiment of the present disclosure may be used as a leg of the walking robot and the robot may be used as an arm through the configuration of the third motor 230.

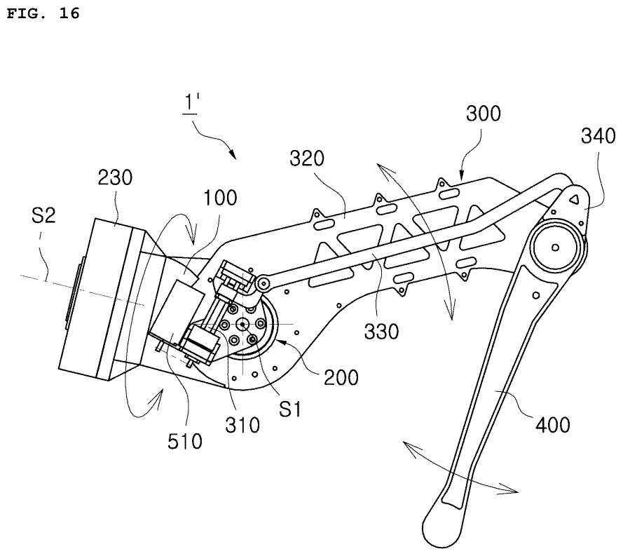

Specifically, as illustrated in FIG. 16, the axis S2 of the third motor 230 may be disposed in a direction intersecting with the axis S1 of the first and second motors 210 and 220, and when the third motor 230 is operated, the main body 100 may be rotated in the forward and reverse directions about the axis S2. Accordingly, the robot 1′ may be used to implement internal rotation and external rotation motions.

Although the robot 1′ according to the second embodiment of the present disclosure is illustrated as having omitted the stiffness adjustment unit 600 applied to the robot 1 according to the first embodiment, the configuration of the stiffness adjustment unit 600 may be selectively added and applied to the robot 1′.

As is apparent from the above description, the robot with active variable stiffness and transmission mechanism according to the present disclosure having the configuration as described above can simultaneously control the transmission ratio and stiffness of the actuation unit using the single motor, thereby increasing the stiffness in the low transmission ratio range to enhance the system bandwidth. In addition, it is possible to decrease the stiffness in the high transmission ratio range to make it resistant to system-applied shocks during operation.

Although the present disclosure has been described with respect to the specific embodiments, it will be apparent to those skilled in the art that the present disclosure is not limited to the above-described embodiments and various changes and modifications are possible without departing from the technical spirit of the invention.

### EXPLANATION OF REFERENCE NUMERALS

1, 1′: Robot
100: Main body
200: Actuation unit
210: First motor
211: Swivel panel
220: Second motor
230: Third motor
S1, S2: Axis
300: Link unit
310: Input link
311: Rod end bearing
320: Ground link
330: Connecting link
340: Output link
400: Swivel unit
500: Control unit
510: Motor
600: Stiffness adjustment unit
610: Fixed bracket
620: Guide rail
630: Movable member
640: Spring

1. A robot comprising:
a main body;
an actuation unit installed in the main body and comprising a first motor to rotate a swivel panel in forward and reverse directions at a predetermined angle;
a link unit comprising an input link coupled in a direction intersecting with an axis of the first motor to the swivel panel so as to be able to idle, a ground link having one end coupled so as to be pivotable about the axis of the first motor, a connecting link having one end reciprocatably screwed to an outer peripheral surface of the input link and the other end disposed in a direction intersecting with the input link, and an output link having one end pivotably coupled to the other end of the connecting link and the other end pivotably coupled to the other end of the ground link;
a swivel unit extending from the other end of the output link in its longitudinal direction by a predetermined length and swiveled at a predetermined angle when the first motor is operated in the forward and reverse directions; and
a control unit configured to control a transmission ratio of the swivel unit depending on the situation by comprising a motor configured to rotate the input link in the forward and reverse directions so as to adjust a length of the input link by increasing or decreasing a distance between the axis of the first motor and one end of the connecting link.

2. The robot according to claim 1, wherein the actuation unit comprises a second motor disposed on the same axis as the first motor and coupled to one end of the ground link to reciprocatably swivel the other end of the ground link about the axis at a predetermined angle.

3. The robot according to claim 2, wherein the ground link has one end integrally coupled to the first motor so that the first motor and the ground link are swiveled simultaneously when the second motor is operated.

4. The robot according to claim 1, wherein the connecting link is in the form of a length-adjustable turnbuckle to adjust a setting angle of the swivel unit.

5. The robot according to claim 1, further comprising a stiffness adjustment unit configured to adjust stiffness depending on the length of the input link, in which:
one end of the input link is hinged to one surface of the swivel panel;
the other end of the input link is disposed as a free end so as to swivel about one end of the input link toward a direction of placement of the connecting link; and
the swivel panel is provided on both sides thereof with a pair of springs with the other end of the input link interposed therebetween to elastically support the other end of the input link.

6. The robot according to claim 5, wherein one end of the input link is hinged to one surface of the swivel panel via a rod end bearing.

7. The robot according to claim 5, wherein the stiffness adjustment unit comprises:
a fixed bracket installed to be spaced apart from and face one surface of the swivel panel with the other end of the input link interposed therebetween;
a guide rail installed in a swivel direction of the swivel panel on an opposite surface of the fixed bracket;
a movable member slidably and reciprocatably coupled to the guide rail and to which the other end of the input link is pivotably coupled; and
the pair of springs fitted to an outer peripheral surface of the guide rail with the movable member interposed therebetween to elastically support the movable member.

8. The robot according to claim 1, further comprising a third motor installed in a direction intersecting with the axis of the first and second motors to rotate the main body in the forward and reverse directions about the axis in the intersection direction.

9. The robot according to claim 8, wherein the swivel unit constitutes a leg or arm of the robot.

10. The robot according to claim 2, further comprising a third motor installed in a direction intersecting with the axis of the first and second motors to rotate the main body in the forward and reverse directions about the axis in the intersection direction.

11. The robot according to claim 3, further comprising a third motor installed in a direction intersecting with the axis of the first and second motors to rotate the main body in the forward and reverse directions about the axis in the intersection direction.

12. The robot according to claim 4, further comprising a third motor installed in a direction intersecting with the axis of the first and second motors to rotate the main body in the forward and reverse directions about the axis in the intersection direction.

13. The robot according to claim 5, further comprising a third motor installed in a direction intersecting with the axis of the first and second motors to rotate the main body in the forward and reverse directions about the axis in the intersection direction.

14. The robot according to claim 6, further comprising a third motor installed in a direction intersecting with the axis of the first and second motors to rotate the main body in the forward and reverse directions about the axis in the intersection direction.

15. The robot according to claim 7, further comprising a third motor installed in a direction intersecting with the axis of the first and second motors to rotate the main body in the forward and reverse directions about the axis in the intersection direction.
